(19) United States
(12) Patent Application Publication
(10) Pub. No.: US 2011/0234614 A1
(43) Pub. Date: Sep. 29, 2011

(54) IMAGE PROCESSING APPARATUS

(75) Inventor: Nana Ohyama, Tokyo (JP)

(73) Assignee: CANON KABUSHIKI KAISHA, Tokyo (JP)

(21) Appl. No.: 13/070,310

(22) Filed: Mar. 23, 2011

(30) Foreign Application Priority Data
Mar. 25, 2010 (JP) 2010-070323

(51) Int. Cl. G09G 5/02

(52) U.S. Cl. 345/589

(57) ABSTRACT

An image processing apparatus is configured to designate an area of an input image signal, enlarge a waveform of a signal included in a designated area among generated waveforms, set a display color of the enlarged waveform to a different color, and output the waveform having the set display color by imposing over the generated waveform.

### BACKGROUND OF THE INVENTION

1. Field of the Invention

The present invention relates to a technique for displaying a distribution of color signals of an image.

2. Description of the Related Art

Conventionally, when an image is captured by a camera or a video camera, an operator determines whether or not a whole image or a main object image has a suitable color and, if necessary, makes an adjustment of the coloring. On the site of photographing, a camera is connected to a vector scope that can display a waveform of an output signal of the camera and can monitor a hue and saturation.

The vector scope expresses the distribution of the color signals of the image by the hue and the saturation. In other words, the distribution of the color signals forms a hue circle. In the hue circle, the hue is represented by an angle and the saturation is represented by a distance from an original point of the circle. Thus, as it goes outward of the circle, the saturation increases. Examples of an image having high saturation include the emerald green sea, the red hibiscus flowers, and the yellow fruits. If the saturation of an image is too high, beat may occur when the image is displayed on a television. Or, if the image is used as a broadcast signal, the color of the image may not be reproduced. Therefore, the operator needs to confirm whether the saturation of the image is not too high by using the vector scope when the operator captures the image.

On the other hand, in a case where a human figure is an object, an impression of the human figure may change even if a small change occurs in hue of a skin of the human figure according to a switch of a scene or the like. Consequently, a fine adjustment of an image quality is required. Japanese Patent Application Laid-Open No. 2009-088886 discloses a display adjustment function for realizing the above adjustment. When this function is realized by the vector scope, since a typical skin color of the human figure has relatively low saturation, the operator uses a function that enlarges the hue circle around the original point of the vector scope. With this function, the operator can confirm the hue of the skin color based on a positional relationship between a mark inside the vector scope and a memory of an outer circle.

However, in a case where the operator captures an image of the human figure, for example, on the beach with the emerald green sea behind the human figure, the operator cannot make confirmations as to whether the saturation is not too high and as to whether the hue of the skin color of the human figure matches at the same time using the vector scope.

### SUMMARY OF THE INVENTION

The present invention is directed to a technique for enabling an operator to precisely confirm a target area while the operator confirms a hue deviation of the whole image.

According to an aspect of the present invention, an image processing apparatus for generating a waveform of an input image signal and outputting the input image signal and the generated waveform to a display device includes an area designation unit configured to designate an area of the input image signal, and an image processing unit configured to enlarge a waveform of a signal included in the area designated by the area designation unit among the generated waveforms, set a display color of the enlarged waveform to a display color different from a display color of the generated waveform, and output the waveform having the set display color by superimposing over the generated waveform.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention

FIG. 1 illustrates a basic configuration of an imaging apparatus according to an exemplary embodiment of the present invention.

FIGS. 2A and 2B illustrate a schematic view of a display of a vector scope according to the exemplary embodiment of the present invention.

FIG. 3 is a color table according to a first exemplary embodiment of the present invention.

FIG. 4 is a schematic view of an image processing control unit according to the first exemplary embodiment of the present invention.

FIGS. 5A through 5F are conceptual views for displaying waveform data of a pattern 1 according to the first exemplary embodiment of the present invention.

FIGS. 6A through 6G are conceptual views for displaying waveform data of a pattern 2 according to the first exemplary embodiment of the present invention.

FIG. 7 is a schematic view of an image processing control unit according to a second exemplary embodiment of the present invention.

FIG. 8 is a flow chart illustrating a calculation method of average values of color difference signals Cb, Cr according to the second exemplary embodiment of the present invention.

FIG. 9 is a schematic view illustrating an enlargement processing according to the exemplary embodiment of the present invention.

### DESCRIPTION OF THE EMBODIMENTS

Various exemplary embodiments, features, and aspects of the invention will be described in detail below with reference to the drawings.

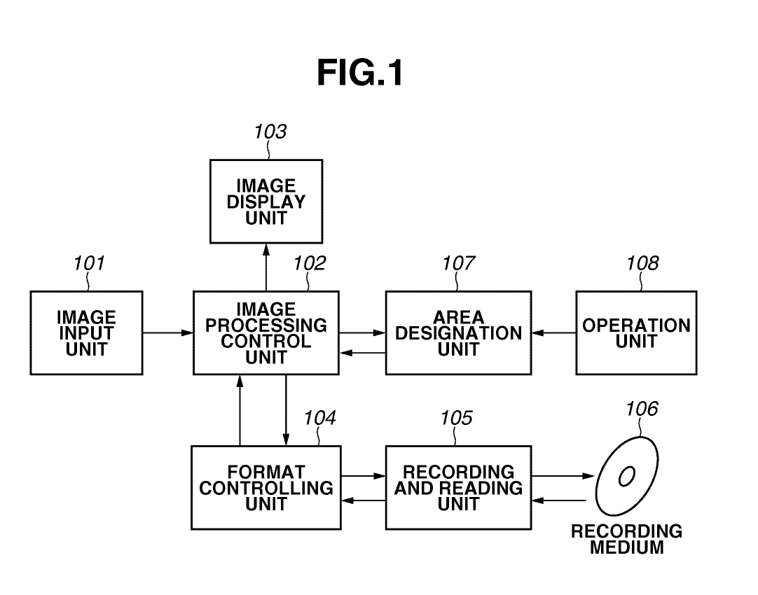

In FIG. 1, an image processing apparatus according to a first exemplary embodiment of the present invention includes an image input unit 101, an image processing control unit 102, an image display unit 103, a format controlling unit 104, a recording and reading unit 105, a removable recording medium 106, an area designation unit 107, and an operation unit 108.

The image input unit 101 may include an imaging unit containing, such as, a plurality of lenses and a charge-coupled device (CCD). The image input unit 101 has a function for processing a predetermined signal with respect to a red-green-blue (RGB) image signal from the CCD, i.e., a function of a white balance processing. The image input unit 101 further has a function for converting an image signal after processed into a luminance signal Y and color difference signals Cb and Cr and outputting the converted signals. An image (i.e., a video image) input by the image input unit 101 is processed by the image processing control unit 102 and displayed by the image display unit 103 including a crystal liquid panel.

The processed image is further converted by the format controlling unit 104 into an image having a format that can be recorded. The converted image is then recorded in the recording medium 106 by the recording and reading unit 105. The image recorded in the recording medium 106 can be read out by the recording and reading unit 105 and converted by the format controlling unit 104 into an image having a format that can be displayed and printed. Then, the converted image is processed by the image processing control unit 102 and displayed by the image display unit 103.

The area designation unit 107 generates a designation area to the input image based on area information corresponding to the image input from the image input unit 101 and according to an area designation operation performed by the operation unit 108.

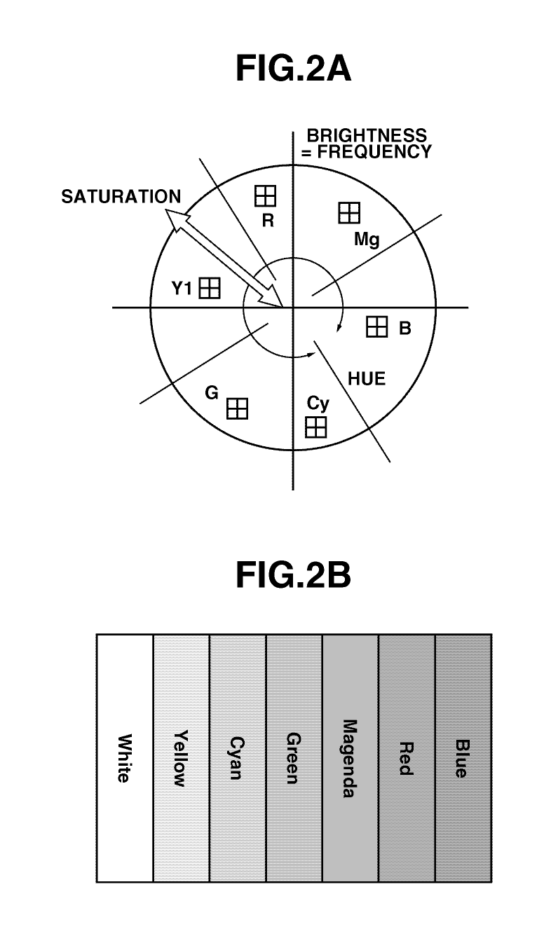

FIG. 2A illustrates a display of a waveform according to the present exemplary embodiment. This display form is generally referred to as a vector scope display. In the vector scope display, a distribution of a color signal of the input image is represented such that the hue is indicated by an angle of the waveform, the saturation is indicated by a distance from an original point, and a frequency in duplicated data is indicated by an intensity of the waveform. Signs in four blocks within a circle indicate a state that a distribution position of the color signal having a 100% color bar illustrated in FIG. 2B is positioned at each of cross over points of the four blocks. Each alphabet represents each color of the color bar. More specifically, Yl represents a yellow color, Cy represents a cyan color, G represents a green color, Mg represents a magenta color, R represents a red color, and B represents a blue color.

In the present exemplary embodiment, the area designation unit 107 selects face area information and sky area information corresponding to the image input from the image input unit 101 to set the designation area of the image according to an instruction from the operation unit 108.

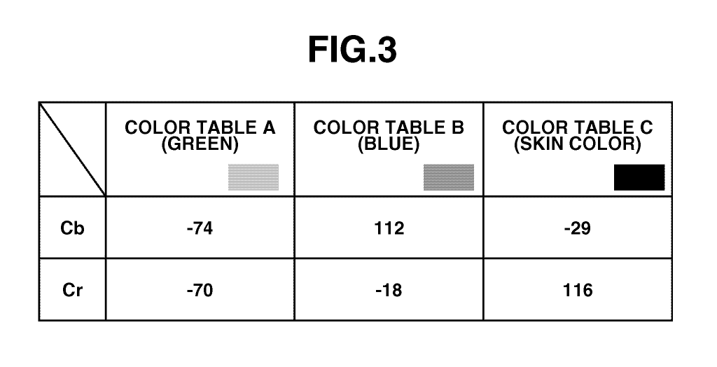

FIG. 3 illustrates combinations of the values of the color difference signals Cb and Cr in color tables indicating display colors of the waveform data. In FIG. 3, the values of the color difference signals Cb and Cr, respectively, are signed 8-bit data. A color table A (green) illustrated in FIG. 3 is referred to with respect to an area outside the designation area. In a case where an inside of the designation area represents the sky area, a color table B (blue) is referred to. In a case where the inside of the designation area represents a face area, a color table C (skin color) is referred to.

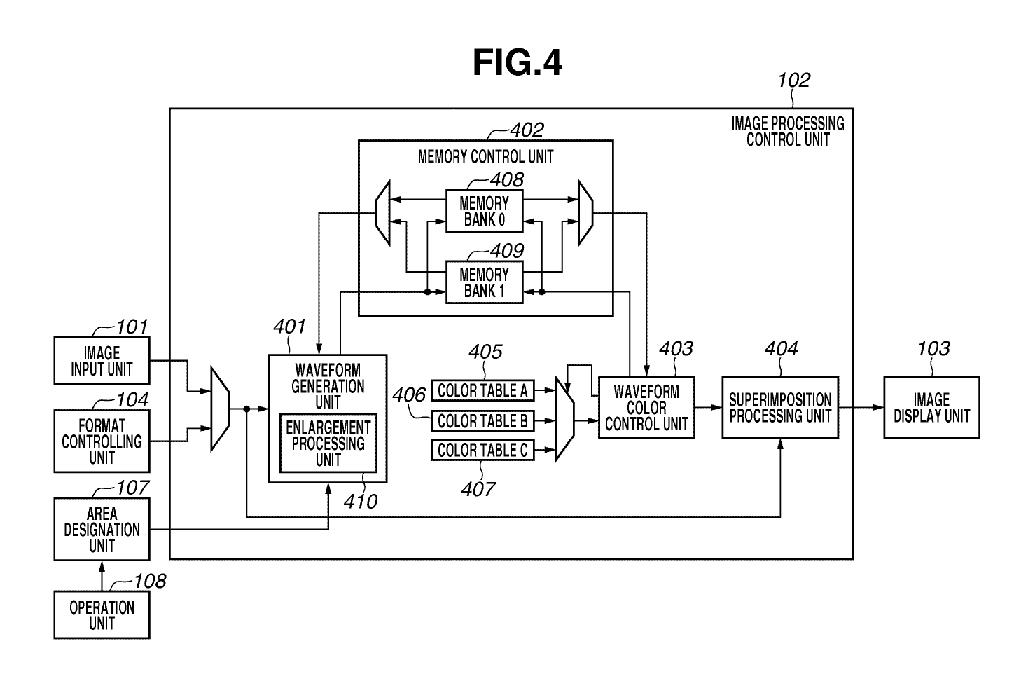

The image processing control unit 102 is described below in detail. FIG. 4 illustrates a configuration of the image processing control unit 102. The image processing control unit 102 includes a waveform generation unit 401, a memory control unit 402, a waveform color control unit 403, a superimposition processing unit 404, a color table A 405, a color table B 406, and a color table C 407.

The memory control unit 402 includes two built-in memories for temporarily storing thus generated waveform data, i.e., a memory bank 0 (408) and a memory bank 1 (409). The memory control unit 402 uses these two built-in memories by switching them for the purposes of waveform generation and waveform reading.

A single piece of waveform data is generated using an image of a single frame during an image display. The memory control unit 402 switches the memory bank 0 (408) and the memory bank 1 (409) for the purposes of the waveform generation and the waveform reading for each frame. The waveform generation unit 401 includes an enlargement processing unit 410 configured to enlarge the waveform data inside the designation area by two times.

Based on the color difference signals Cb and Cr of the image input from the image input unit 101 or the format controlling unit 104, the waveform generation unit 401 generates data of the waveform of the vector scope. The memory control unit 402 stores the generated data in the memory bank 0 (408). In other words, the waveform generation unit 401 regards 8 bit coordinate values b-y and r-y converted from the color difference signals Cb and Cr of the input image as rectangular coordinates and generates addresses for memory accessing. A method for converting the color difference signals Cb and Cr of the input image into the coordinate values b-y and r-y is described below.

In the present exemplary embodiment, the waveform generation unit 401 sets the coordinate value b-y converted from the color difference signal Cb of the input image to a horizontal axis and sets the coordinate value r-y converted from the color difference signal Cr to a vertical axis. Then, an accessing control is performed with respect to the two-dimensionally arrayed memory. In the accessing control here, initially, data of the corresponding address is read out. The waveform generation unit 401 multiplies the read-out data and an arbitrary gain together and adds the multiplied data to the read-out data.

The memory control unit 402 writes back the data into the original address again. Accordingly, the control can be performed such that data values become larger in a portion of a higher frequency. After the processing for a single frame in displaying the image is completed, when the processed frame is displayed on the image display unit 103, a luminance signal level of a portion of a higher frequency is brighter and a luminance signal level of a portion of a lower frequency is darker from the operator's viewpoint.

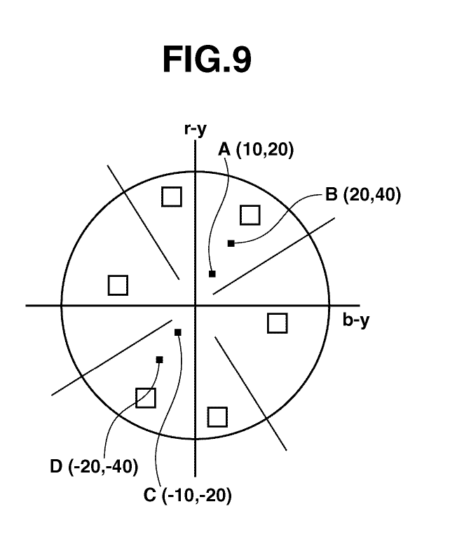

At the time, if the waveform data is inside the designation area, the enlargement processing unit 410 enlarges the waveform using the designation area information from the area designation unit 107. More detailed description is made below. In a case where the present color difference signals Cb and Cr input from the image input unit 101 are inside the designation area, the enlargement processing unit 410 enlarges the values of b-y and the r-y having been converted into the coordinates of the waveform of the vector scope by two times around the original point in FIG. 9. For example, coordinates A (i.e., (b-y, r-y)=(10, 20)) are enlarged by two times and are converted into coordinates B (i.e., (b-y′, r-y′)=(20, 40)). Coordinates C (i.e., (b-y, r-y)=(−10, −20)) are enlarged by two times and are converted into coordinates D (i.e., (b-y′, r-y′)=(−20, −40)).

At the time, the enlargement processing unit 410 does not perform the waveform generation processing with respect to the coordinates which will be outside the memory area for the waveform of the vector scope when the coordinates are enlarged. Further, based on information indicating whether the coordinates represents the designation area from the area designation unit 107, a designation area flag corresponding to the waveform data is associated with the waveform data and is stored in the memory bank 0 (408) of the built-in memory 402.

In a case where the waveform data is inside the designation area, the waveform data is subjected to the enlargement processing and, after an address for accessing to the memory is generated, the data of the corresponding address is read out. If the designation area flag of the read out data is invalid, a zero data is used instead of the read out data. Further if the designation area flag is valid, as it is described above, the read out data and an arbitrary gain are multiplied together and the multiplied data is added to the read out data. Thus, the added data is written back to the original address via the memory control unit 402 again. At the time, the designation area flag is remained as valid, and is stored in the memory bank 0 (408) of the built-in memory 402 by being associated with the waveform data.

If the waveform data is outside the designation area, after an address for accessing to the memory is generated, data of the corresponding address is read out. If a designation area flag of the read out data is valid, the read out data, as it is, is written back to the same address. In a case where the designation area flag is invalid, as it is described above, the read out data and the predetermined gain are multiplied together and the multiplied data is added to the read out data. Thus, the added data is written back to the original address again via the memory control unit 402. According to the above described processing, waveform data is generated such that the waveform data inside the designation area having been enlarged is overwritten onto the waveform data outside the designation area.

When the waveform generation unit 401 completes to generate the waveform data corresponding to the image signal for a single frame, from a timing of the next frame, the generated waveform data is stored by the memory control unit 402 into the memory bank 1 (409). The memory control unit 402 reads out the waveform data stored in the memory bank that is not presently accessed by the waveform generation unit 401. Then, the read out value is set to a luminance signal and the color difference signal corresponding thereto is set to a green-color waveform data with reference to the color table A 405 which represents a combination of color differences preliminary set at the time when the waveform is displayed, by the waveform color control unit 403

At the time, the memory control unit 402 concurrently reads out the designation area flag having been associated with the waveform data from the built-in memory. If the waveform data is inside the designation area, the color table to be referred to is changed. If the designation area is a face area, the waveform color control unit 403 refers to the color table C and converts the data of the designation area into waveform data having a skin color. If the designation area is a sky area, the waveform color control unit 403 refers to the color table B and converts the data of the designation area into waveform data having a blue color. Then, the superimposition processing unit 404 superimposes the waveform data onto the image data to be displayed on the image display unit, and the resulting data is displayed on the image display unit 103.

In the present exemplary embodiment, provided that a standard color space (i.e., BT.601) is used, a conversion method is described below.

The color difference signals Cb (analog) and Cr (analog) are obtained by the following formula according to a color conversion formula described in the International Telecommunication Union Radio communications Sector (ITU-R) BT.601.

$$\begin{matrix}[ Formula 1 ] & \\ \{ \begin{matrix}Cb ( analog ) = 0.564 \times ( B - Y ) \\ Cr ( analog ) = 0.713 \times ( R - Y )\end{matrix} & ( Formula 1 )\end{matrix}$$

The color difference signals Cb (digital) and Cr (digital) are obtained by the following formula.

$$\begin{matrix}[ Formula 2 ] & \\ \{ \begin{matrix}Cb ( digital ) = 224 \times Cb ( analog ) + 128 \\ Cr ( digital ) = 224 \times Cr ( analog ) + 128\end{matrix} & ( Formula 2 )\end{matrix}$$

The formula 1 is substituted for the formula 2 to deform the formula 2. The values B-Y and R-Y are obtained by the following formula.

$$\begin{matrix}[ Formula 3 ] & \\ \{ \begin{matrix}B - Y = ( Cb ( digital ) - 128 ) / ( 224 \times 0.564 ) \\ R - Y = ( Cr ( digital ) - 128 ) / ( 224 \times 0.713 )\end{matrix} & ( Formula 3 )\end{matrix}$$

Further, provided that the formula 3 is multiplied by a subtraction coefficient according to the Society of Motion Picture and Television Engineers (SMPTE) 170M to convert the values into 8-bit data, i.e., into b-y and r-y, the values b-y and the r-y are obtained by the following formula.

$$\begin{matrix}[ Formula 4 ] & \\ \{ \begin{matrix}b - y = 0.492111 \times ( B - Y ) \times 255 \approx Cb - 128 \\ r - y = 0.877283 \times ( R - Y ) \times 255 \approx ( Cr - 128 ) \times 1.4\end{matrix} & ( Formula 4 )\end{matrix}$$

By using the values of the above formula 4, the coordinates b-y and r-y of the display of the waveform of the vector scope can be obtained.

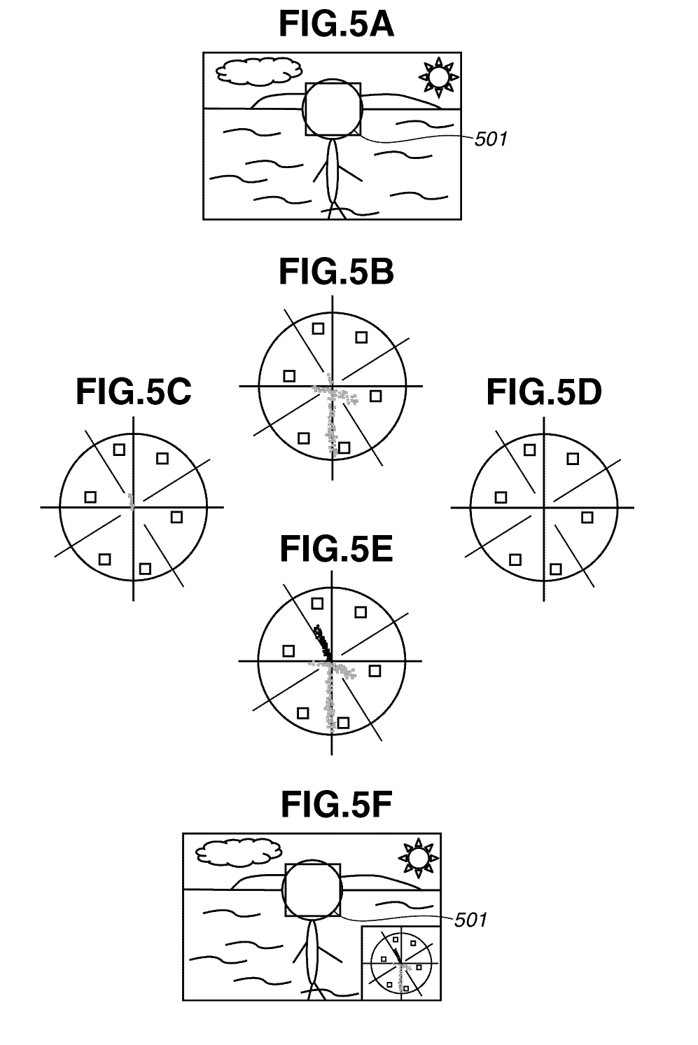

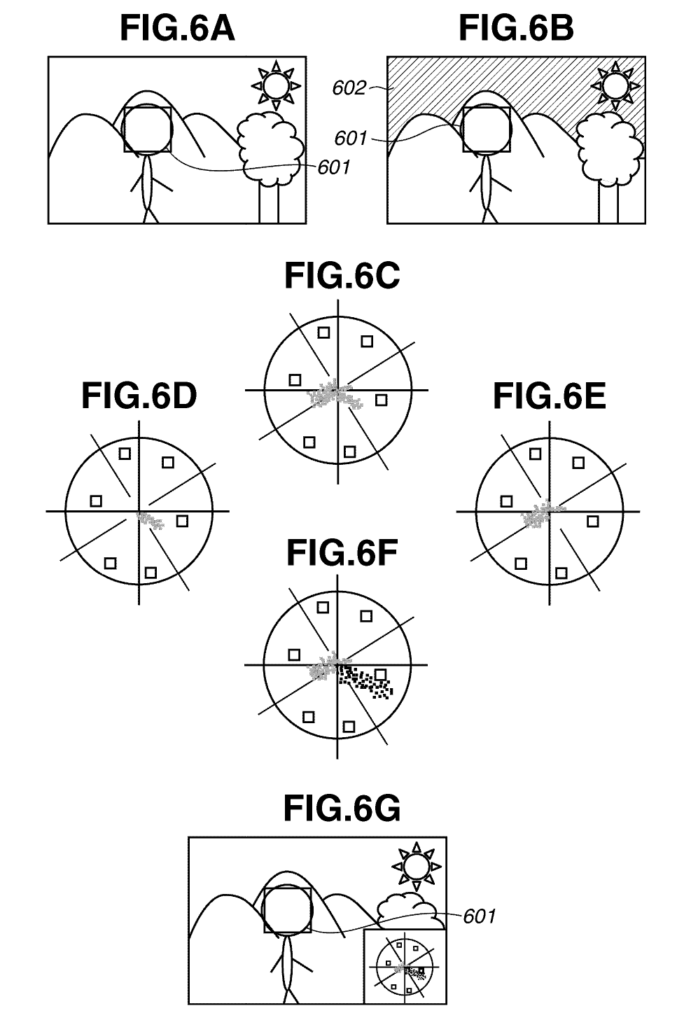

A captured image and an image of the vector scope to be displayed on the image display unit 103 according to the present exemplary embodiment are illustrated in FIGS. 5A through 5F and FIGS. 6A through 6G.

In the present exemplary embodiment, it is provided that the face area information or the sky area information corresponding to the image input from the image input unit 101 is the designation area. The operator sets which piece of information is to be used via the operation unit 108. Each of these two patterns is described below.

Pattern 1. A Case where the Face Area is the Designation Area:

The case where the face area is the designation area is described with reference to FIGS. 5A through 5F. FIG. 5A illustrates the image data input, from the image input unit 101 and a designation area 501 is based on the face area information. FIG. 5B illustrates the waveform data of the vector scope of the input image data. FIG. 5C illustrates waveform data existing inside the designation area. FIG. 5D illustrates the waveform data existing outside the designation area. FIG. 5E illustrates waveform data enlarged such that only the waveform data inside the designation area is enlarged by two times.

At the time, the waveform data outside the designation area becomes green waveform data with reference to the color table A. The waveform data inside the designation area becomes skin-color waveform data with reference to the color table C. The waveform data of the vector scope is positioned on a lower right position of the input image data and is superimposed over the input image data, so that the waveform data is displayed on the image display unit 103. An example of the displayed waveform data is illustrated in FIG. 5F.

Pattern 2. A Case where the Designation Area is the Sky Area:

The case where the designation area is the sky area is described below with reference to FIGS. 6A through 6G. FIG. 6A illustrates the image data input from the image input unit 101. A shaded area 602 illustrated in FIG. 6B is an area indicated by the sky area information and is the designation area. A face area 601 is not used in the present pattern. FIG. 6C illustrates the waveform data of the vector scope of the input image data. FIG. 6D illustrates the waveform data existing inside the designation area. FIG. 6E is the waveform data existing outside the designation area. FIG. 6F illustrates waveform data that only the waveform data inside the designation area is enlarged by two times.

At the time, the waveform data outside the designation area is set to green waveform data with reference to the color table A. The waveform data inside the designation area is set to blue waveform data with reference to the color table B. The waveform data of the vector scope is positioned on lower right position of the input image data and is subjected to the superimposition processing. FIG. 6G illustrates that an example of the image with the waveform data of the vector scope superimposed thereon is displayed on the image display unit 103. A background color of the vector scope is changed from a background color of FIG. 5F for the sake of easy viewing upon description thereof.

As described above, in the present exemplary embodiment, the image processing apparatus displays the hue of the input image in the form of the waveform via the vector scope. Further, the waveform of the target image area is enlarged and displayed with a color of waveform different from a color of the waveform outside the target image area. With such a display, the operator can confirm the target area with a high accuracy while confirming a hue deviation of the entire image.

In the present exemplary embodiment, the face area and the sky area are used as the designation area of the image. However, focus area information and area designation information of the image data via the operation unit 108 may be used as the designation area of the image. The waveform data inside the designation area is enlarged by two times. However, a magnification may be arbitrary set by the user.

In the present exemplary embodiment, a case where there is only one designation area is described. However, in a case where there is a plurality of designation areas, the same color table inside the designation area may be referred to, or, alternatively, a plurality of color tables may be prepared for referring to a different color table in each of the areas.

A second exemplary embodiment of the present invention is described below. The waveform display according to the second exemplary embodiment is identical to that according to the first exemplary embodiment illustrated in FIG. 2A, so that the description thereof is omitted here. Further, a configuration of an apparatus according to the present exemplary embodiment is also identical to the configuration of the apparatus according to the first exemplary embodiment, so that the description thereof is omitted here. In the present exemplary embodiment, the color table A (green) is referred to with respect to the area outside the designation area among the combination of the values in FIG. 3.

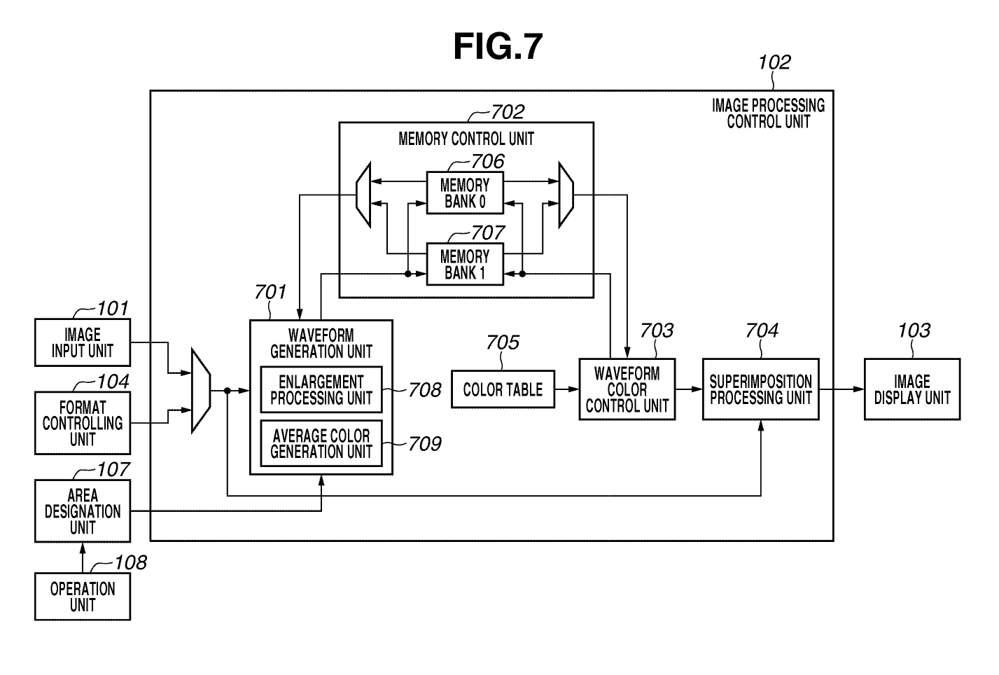

The image processing control unit 102 according to the present exemplary embodiment is described below in detail. FIG. 7 illustrates a configuration of the image processing control unit 102. The image processing control unit 102 includes a waveform generation unit 701, a memory control unit 702, a waveform color control unit 703, a superimposition processing unit 704, and a color table 705. The memory control unit 702 includes two built-in memories for temporarily storing generated waveform data, i.e., a memory bank 0 (706) and a memory bank 1 (707). The memory control unit 702 uses these two built-in memories by switching the memories for the purposes of generation of waveform and reading of the waveform.

A single piece of waveform data is generated using a single frame while the image is displayed. The memory control unit 702 alternately switches the memory bank 0 (706) and the memory bank 1 (707) for the purposes of the generation of the waveform and the reading of the waveform for every frame. The waveform generation unit 701 includes an enlargement processing unit 708 configured to enlarge the waveform data inside the designation area by two times and an average color generation unit 709 configured to calculate an average color of the designation area.

Based on the color difference signals Cb and Cr of the image input from the image input unit 101 or the format controlling unit 104, the waveform generation unit 701 generates data of the waveform of the vector scope and stores the data in the memory bank 0 (706) by the memory control unit 702. More specifically, the waveform generation unit 701 regards the 8-bit values b-y and r-y converted from the color difference signals Cb and Cr of the input image as rectangular coordinates and generates an address for memory accessing. A method for converting into the values b-y and r-y is identical to the method according to the first exemplary embodiment, so that the description thereof is omitted here.

In the present exemplary embodiment, the waveform generation unit 701 sets the value b-y converted from the color difference signal Cb of the input image to the horizontal axis and sets the value r-y converted from the color difference signal Cr of the input image to the vertical axis. The waveform generation unit 701 controls accessing to the memory which is regarded as a two-dimensional array. In this access control, data of the corresponding address is initially read out. The waveform generation unit 701 multiplies the read out data and an arbitrary gain together. Then, the waveform generation unit 701 adds the multiplied data to the read out data.

The memory control unit 702 writes the data back to the original address again. Accordingly, the control can be performed such that the data values of the image of a higher frequency become larger. After the processing for a single frame in displaying the image is completed, when the processed frame is displayed on the image display unit 103, a luminance signal level of a portion of a higher frequency is brighter and a luminance signal level of a portion of a lower frequency is darker from the operator's viewpoint.

At the time, the enlargement processing unit 708 enlarges the waveform with using the designation area information from the area designation unit 107. A method for enlarging the waveform is performed in the manner similar to the enlargement method performed in the first exemplary embodiment, so that the description thereof is omitted here. At the time, the coordinates coming outside the memory area for the waveform of the vector scope according to the enlargement processing is not subjected to the waveform generation processing. Further, based on the information whether the information indicates the designation area from the area designation unit 107, a designation area flag corresponding to the waveform data is associated with the waveform data and stored in the memory bank 0 (706) of the memory control unit 702.

In a case of the waveform data inside the designation area, the waveform data is subjected to the enlargement processing and an address for accessing to the memory is generated. Thereafter, data of the corresponding address is read out. In a case where the designation area flag of the read out data is invalid, zero data is used instead of the read out data. In a case where the designation area flag is valid, as it is described above, the read out data is multiplied by an arbitrary gain and the multiplied data is added to the read out data. Thus, the added data is written back to the original address again via the memory control unit 702.

At the time, the designation area flag is associated with the waveform data as it is remained valid and stored in the memory bank 0 (706) of the memory control unit 702. The average color generation unit 709 calculates an average color of the colors inside the designation area of the input image and stores a combination of values of the color difference signals Cb and Cr as a color table of the colors inside the designation area by associating with a frame, in the memory bank 0 (706) of the memory control unit 702. A method for calculating the average color performed by the average color generation unit 709 is described below.

In a case where the waveform data is outside the designation area, after an address for accessing to the memory is generated, data of the corresponding address is read out. If a designation area flag of the read out data is valid, the read out data, as it is, is written back to the same address. Whereas, in a case where the designation area flag is invalid, as it is described above, the read out data is multiplied by an arbitrary gain and the multiplied data is added to the read out data. Thus, the added data is written back to the original address again via the memory control unit 702. The above described processing generates waveform data such that the waveform data which is inside the designation area and is subjected to the enlargement processing is overwritten onto the waveform data outside the designation area.

After the waveform generation unit 701 completes to generate waveform data corresponding to the image signal of a single frame, from a timing of the next frame, the generated waveform data is sequentially stored in the memory bank 1 (707) by the memory control unit 702. The memory control unit 702 reads out the waveform data stored in the memory bank to which the waveform generation unit 701 is not presently accessed. The read out value is converted into a luminance signal and the corresponding color difference signal is converted into green waveform data with reference to the color table (705) including a combination of the color difference signals preliminary set by the waveform color control unit 703 while the waveform is displayed.

At the time, the memory control unit 702 reads out the designation area flag having been associated with the waveform data together with the color table of the data inside the designation area from the built-in memory. In a case where the data is inside the designation area, the data is set to the waveform data having an average color inside the designation area with reference to the color table inside the designation area. Then, the superimposition processing unit 704 superimposes, the waveform data onto the image data to be displayed on the image display unit. The superimposition processing unit 704 causes the image display unit 103 to display the resulting image data thereon.

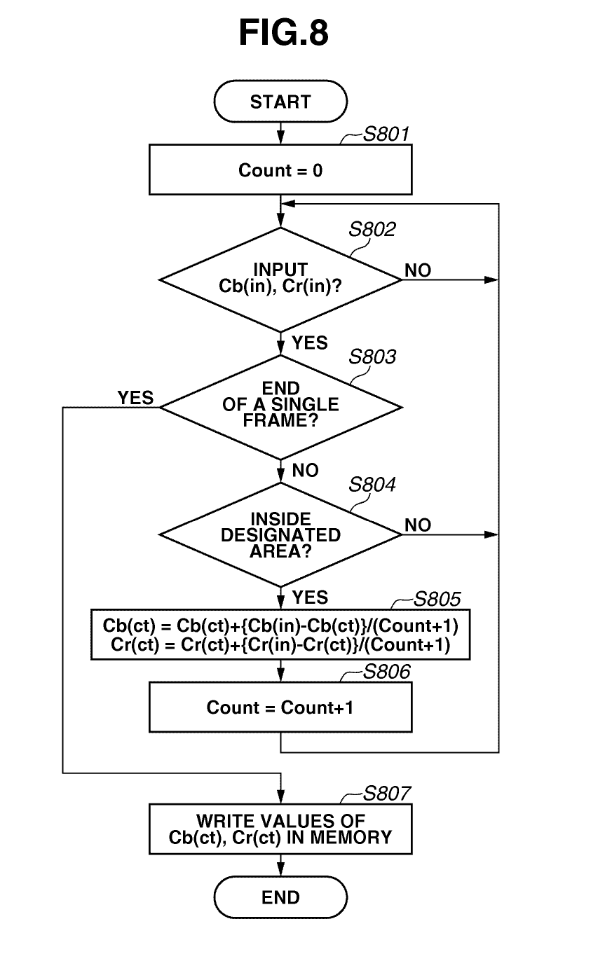

A method for calculating the color difference signals Cb and Cr of the color tables inside the designation area in a single frame of the input image data according to the present exemplary embodiment is described with reference to FIG. 8. The color difference signals Cb and Cr of the input image data are set to 8-bit data and treated as data without a code during the calculation thereof. Data per a single pixel unit wherein an image of a single frame is subjected to raster scanning is sequentially input as the input image data. An operation of each step is controlled by the waveform generation unit 701 and the memory control unit 702.

In step S801, a count parameter for counting the number of pieces of data of the designation area in the input image is cleared to zero. If the color difference signals Cb (in) and Cr (in) of a single pixel is input as the input image data (YES in step S802), the processing proceeds to step S803.

In step S803, if the processing for the single frame is not completed (NO in step S803) and, in step S804, the presently input data Cb (in) and Cr (in) are inside the designation area (YES in step S804), the processing proceeds to step S805. In step S805, an average value up to now is calculated using these values. Values Cb (ct) and Cr (ct) at the time represent the color table values of the waveform data of the designation area. In step S806, the data count of the designation area is counted up by 1.

In step S804, if the presently input data Cb (in) and Cr (in) are not inside the designation area (NO in step S804), no processing is performed. Until the processing for the single frame is completed, steps S802 through S806 are repeated.

In step S803, if the processing for the single frame is completed (YES in step S803), then in step S807, the values of Cb (ct) and Cr (ct) are associated with the frame and stored in the memory bank of the memory control unit 702 in which the waveform data is stored. According to the above, average values of the color difference signals Cb and Cr of the designation area are calculated to be used as the color table of the waveform data of the designation area.

A display format in the present exemplary embodiment is identical to that in the first exemplary embodiment, so that a description thereof is omitted here.

As described above, in the present exemplary embodiment, the image processing apparatus displays the distribution of the color signals in the form of the waveform with using the color difference signals of the input image, enlarges only the waveform of the designated designation area, and calculates an average color of the designation area, thereby displaying the inside of the designation area and the outside of the designation area with different colors. Accordingly, the target areas can be confirmed precisely and clearly with related colors while confirming the deviation of the hue of the whole image.

The enlargement processing method and the method for calculating the average values of the values Cb and Cr of the designation area data used in each of the above described exemplary embodiments are mere examples. The present invention is not limited to the above methods.

In the above described exemplary embodiments, the area designation information of the image data according to the operation unit 108 is used as the designation area of the image. However, the face area information and the focus area information may also be used as the designation area of the image.

Further, the image input unit 101 is the imaging unit in each of the above described exemplary embodiments. However, the image input unit 101 may be any device as far as the device has an image input function and thus may be a reading unit for reading a captured image from the a predetermined detachable recording medium or a receiving unit for receiving a captured image from a communication unit such as a network.

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2010-070323 filed Mar. 25, 2010, which is hereby incorporated by reference herein in its entirety.

What is claimed is:

1. An image processing apparatus for generating a waveform of an input image signal and outputting the input image signal and the generated waveform to a display device, the image processing apparatus comprising:
an area designation unit configured to designate an area of the input image signal; and
an image processing unit configured to enlarge a waveform of a signal included in the area designated by the area designation unit among the generated waveforms, set a display color of the enlarged waveform to a display color different from a display color of the generated waveform, and output the waveform having the set display color by superimposing over the generated waveform.

2. The image processing apparatus according to claim 1, wherein each waveform indicates a hue and saturation of the image signal.

3. The image processing apparatus according to claim 1, wherein the image processing unit sets a color preliminary associated with the designation area to a display color of the waveform of the designation area.

4. The image processing apparatus according to claim 1, wherein the designation area is determined according to image information corresponding to the image signal.

5. The image processing apparatus according to claim 4, wherein the image information is any one of face area information, sky area information, focus area information, or area designation information in the image signal input by a user.

6. The image processing apparatus according to claim 3, wherein, if the image information is the face area information, the image processing unit sets a color of the waveform of the designation area to a skin color, and if the image information is the sky area information, the image processing unit sets a color of the waveform of the designation area to a blue color.

7. The image processing apparatus according to claim 3, wherein the image processing unit sets an average color of the image signal of the designation area to a color of the waveform of the designation area.

8. The image processing apparatus according to claim 1 further comprising a designation area flag indicating whether a waveform is the waveform of the designated area or the waveform of the undesignated area.
